(19) United States
(12) Patent Application Publication
(10) Pub. No.: US 2014/0027414 A1
(43) Pub. Date: Jan. 30, 2014

(54) HYBRID WELDING SYSTEM AND METHOD OF WELDING

(71) Applicants: Dechao LIN, Greer, SC (US); Brian L. TOLLISON, Honea Path, SC (US); Srikanth Chandrudu KOTTILINGAM, Simpsonville, SC (US); David SCHICK, Greenville, SC (US); Yan CUI, Greer, SC (US)

(72) Inventors: Dechao LIN, Greer, SC (US); Brian L. TOLLISON, Honea Path, SC (US); Srikanth Chandrudu KOTTILINGAM, Simpsonville, SC (US); David SCHICK, Greenville, SC (US); Yan CUI, Greer, SC (US)

(73) Assignee: GENERAL ELECTRIC COMPANY, Schenectady, NY (US)

(21) Appl. No.: 13/558,963

(22) Filed: Jul. 26, 2012

(51) Int. Cl. B23K 26/20

(52) U.S. Cl. 219/121.64; 219/121.63

(57) ABSTRACT

A hybrid welding system including a hybrid welding apparatus and method of welding are provided. The hybrid welding apparatus includes a laser, an electric arc welder with a non-consumable electrode and a wire feeding device. The electric arc welder provides an electric arc without feeding a welding wire. The wire feeding device is arranged and disposed to feed a wire to a treatment area, which is located between the projections of laser beam and the electric arc. The laser and the electric arc welder are arranged and disposed to direct energy toward at least two adjacent components to form a common molten pool. The wire is fed by the wire feeding device into the common molten pool created by the laser and the electric arc.

### FIELD OF THE INVENTION

This invention relates to joining technology generally, and specifically, to a hybrid welding system and apparatus and a method for joining components using hybrid welding technology.

### BACKGROUND OF THE INVENTION

Hybrid laser arc welding is a method of welding two pieces of metal together which typically combines laser beam welding with electric arc welding, for example, on the same side of a joint between the pieces of metal to simultaneously direct both a laser beam and an electric arc at one welding zone to produce a common molten metal pool which solidifies to form a weld.

Electric arc welders of the hybrid laser arc welder include welders having consumable electrodes, such as, but not limited to, a gas metal arc welder (GMAW), a flux cored arc welder (FCAW) and welders having non-consumable electrodes with wire feeding, such as, but not limited to, a gas tungsten arc welder (GTAW) with wire feeding and a plasma arc welder (PAW) with wire feeding.

Although a hybrid laser arc welder with a consumable electrode arc welder, a GMAW, for example, may allow for a high welding deposition rate and welding speed up to 120 inches per minute in mild-steel, low alloy steel, structural steel, and stainless steel, splattering is an unwanted side effect. The splattering occurs along the weld line and is a result of the metal transfer that occurs from the consumable electrode to the molten pool during the welding process. Prior to use of the welded components, the weld line of the components must be cleaned to remove the splattering. The cleaning step is an additional processing step that requires additional time and labor. Although hybrid laser arc welders including a laser and non-consumable electrode, for example, GTAW or PAW, provides a process with less splatter than a GMAW, welding speeds may drop because if the wire is delivered to the front of laser beam in the laser lead case, a portion of laser power will be used to melt the delivering wire so as to reduce the laser power going to the substrate for deep penetration, in this case, laser energy is consumed to melt the filler metal. In addition, if the wire is delivered to the front of the electric arc welder in the arc leading case, the arc from the GTAW or PAW will have to melt the delivering wires, which also limits the welding speed.

Accordingly, a need exists in the art for an improved welding apparatus and corresponding method of welding that allows for splatter free and high welding speeds. Therefore, a hybrid welding system and apparatus and a method of welding that do not suffer from the above drawbacks are desirable in the art.

### SUMMARY OF THE INVENTION

According to an exemplary embodiment of the present disclosure, a hybrid welding system is provided. The hybrid welding system includes a hybrid welding apparatus, the hybrid welding apparatus having a laser and an electric arc welder with a non-consumable electrode. The laser and the electric arc welder with the non-consumable electrode are arranged and disposed to direct energy toward at least two adjacent components to form a shared molten pool. The hybrid welding system includes a wire feeding device situated between the laser and the non-consumable electrode electric arc welder. The wire feeding device is arranged and disposed to feed a wire to the shared molten pool to form a common molten pool. The common molten pool is operable to join the at least two adjacent components without splattering and at a high constant weld speed.

According to another exemplary embodiment of the present disclosure a method of welding at least two adjacent components is provided. The method includes providing a hybrid welding apparatus, directing energy toward one or both of the adjacent components, providing a wire feeding device and feeding the wire. The hybrid welding apparatus, the hybrid welding apparatus includes a laser and an electric arc welder with a non-consumable electrode. The laser and the electric arc welder with the non-consumable electrode are arranged and disposed to direct energy toward at least two adjacent components to form a shared molten pool. The method includes directing energy toward one or both of the adjacent components with the hybrid welding apparatus to form the shared molten pool. The method includes providing a wire feeding device situated between the laser and the electric arc welder with the non-consumable electrode. The wire feeding device is arranged and disposed to feed a wire to the shared molten pool to form a common molten pool. The method includes feeding the wire into the shared molten pool to form a common molten pool. The common molten pool is operable to join the at least two adjacent components without splattering and at a high constant weld speed.

Other features and advantages of the present disclosure will be apparent from the following more detailed description of the preferred embodiments, taken in conjunction with the accompanying drawings which illustrate, by way of example, the principles of the disclosure.

### BRIEF DESCRIPTION OF THE DRAWINGS

FIG. 1 is a perspective view of a schematic representation of the hybrid welding system and apparatus of the present disclosure.

FIG. 2 is a schematic top view of FIG. 1 with the hybrid welding apparatus removed.

FIG. 3 is a flow chart of the welding method using the hybrid welding system of the present disclosure.

FIG. 4 is a schematic view of the welding device of Reference Example 1.

FIG. 5 is a cross-sectional view taken in the direction 5-5 of FIG. 4 of a weld created by the welding device of Reference Example 1.

FIG. 6 is a top view of the splattering created by the welding device of Reference Example 1.

FIG. 7 is a schematic view of the welding device of Reference Example 2.

FIG. 8 is a cross-sectional view taken in the direction 8-8 of FIG. 7 of an incomplete weld created by the welding device of Reference Example 2.

FIG. 9 is a schematic view of the hybrid welding apparatus of the present disclosure.

FIG. 10 is a cross-sectional view take in the direction 10-10 of FIG. 9 of a full penetration weld created by the hybrid welding apparatus of the present disclosure.

FIG. 11 is a top view of the splatter-free weld obtained by using the present disclosure.

Wherever possible, the same reference numbers will be used throughout the drawings to represent the same parts.

### DETAILED DESCRIPTION OF THE INVENTION

Provided is a hybrid welding system and a method of welding that do not suffer from the drawbacks in the prior art and provides a reduced overall heat input at high welding speeds and is substantially splatter-free.

One advantage of an embodiment of the present disclosure includes obtaining full penetration splatter-free welds and weld repairs in mild-steel, low allow steel, structural steel, stainless steel, superalloys, and other steel alloys. Another advantage of the present disclosure is the use of minimal heat input to join adjacent components. Yet another advantage of the present disclosure is higher welding speeds and lower overall heat input. Yet another advantage of the present disclosure is a high-speed splatter-free welding process that allows for laser or non-consumable electrode electric arc leading to form the weld. Yet another advantage of the present disclosure is prevention of laser power loss from wire melting.

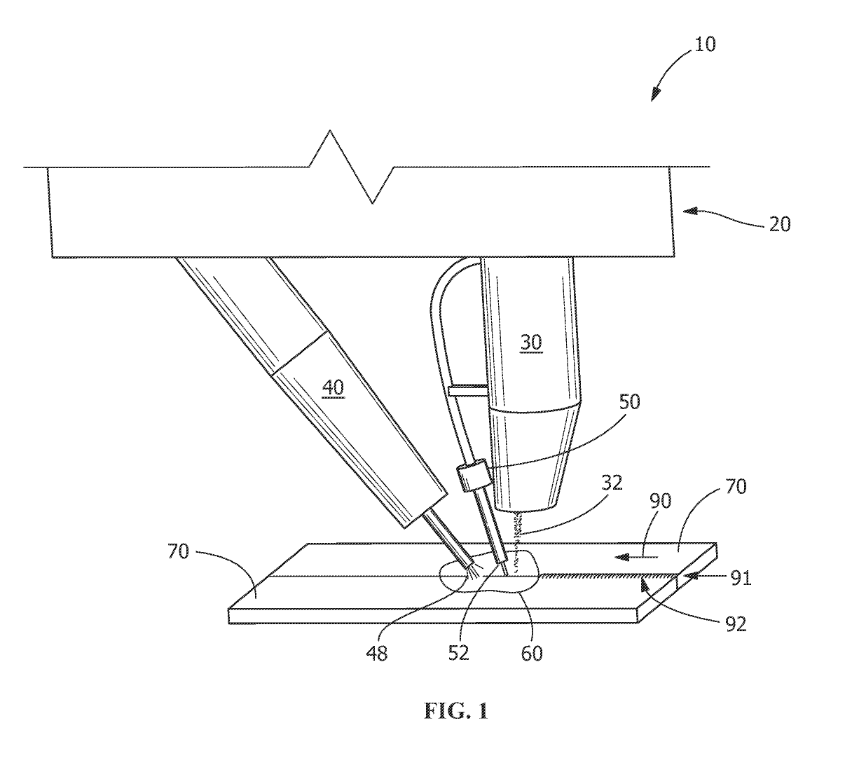

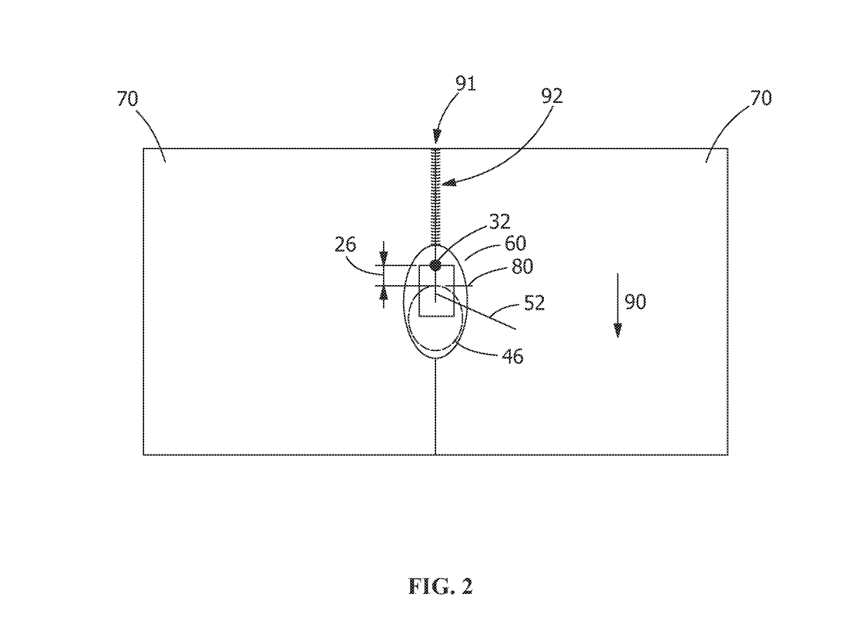

FIG. 1 schematically illustrates a hybrid welding system 10 including a hybrid welding apparatus 20 of the present disclosure. Hybrid welding apparatus 20 includes a laser 30 and an electric arc welder with non-consumable electrode 40. Hybrid welding apparatus 20 includes a wire feeding device 50 for feeding a wire 52. Wire feeding device 50 is arranged and disposed to feed wire 52 to a shared molten pool 80 (see FIG. 2) formed between laser beam 32 and arc 48 of electric arc welder with non-consumable electrode 40 to form common molten pool 60. In one embodiment, wire 52 and wire feeding device 50 are located half-way between electric arc welder with non-consumable electrode 40 and lasers 30. In another embodiment, wire 52 and wire feeding device 50 are located closer to electric arc welder with non-consumable electrode 40 than laser 30. Laser 30 and electric arc welder with non-consumable electrode 40 are arranged and disposed to direct energy toward at least two adjacent components 70 to form shared molten pool 80. Wire 52 of wire feeding device 50 is fed into shared molten pool 80 form a common molten pool 60 (see FIG. 2) operable to provide a full penetration weld 92 to join at least two adjacent components 70 at a high constant weld speed of at least 80 inches per minute (ipm) without splattering along weld line 91.

In one embodiment, laser 30 is selected from a Nd: YAG laser, a CO₂ laser, a fiber laser, and a disk laser. Electric arc welder 40 is selected from welders having non-consumable electrodes with wire feeding, such as, but not limited to, a gas tungsten arc welder (GTAW) with wire feeding and a plasma arc welder (PAW) with wire feeding.

Components 70 include any materials that are joinable or weldable, but generally include materials, such as, but not limited to, aluminum, titanium, steel, stainless steel, brass, copper, nickel, beryllium-copper, superalloy, alloys thereof and combinations thereof Hybrid welding system 10 is especially suitable for use with stainless steel alloys, such as, but not limited to mild-steel, low alloy steel, structural steel, stainless steel, and combinations thereof.

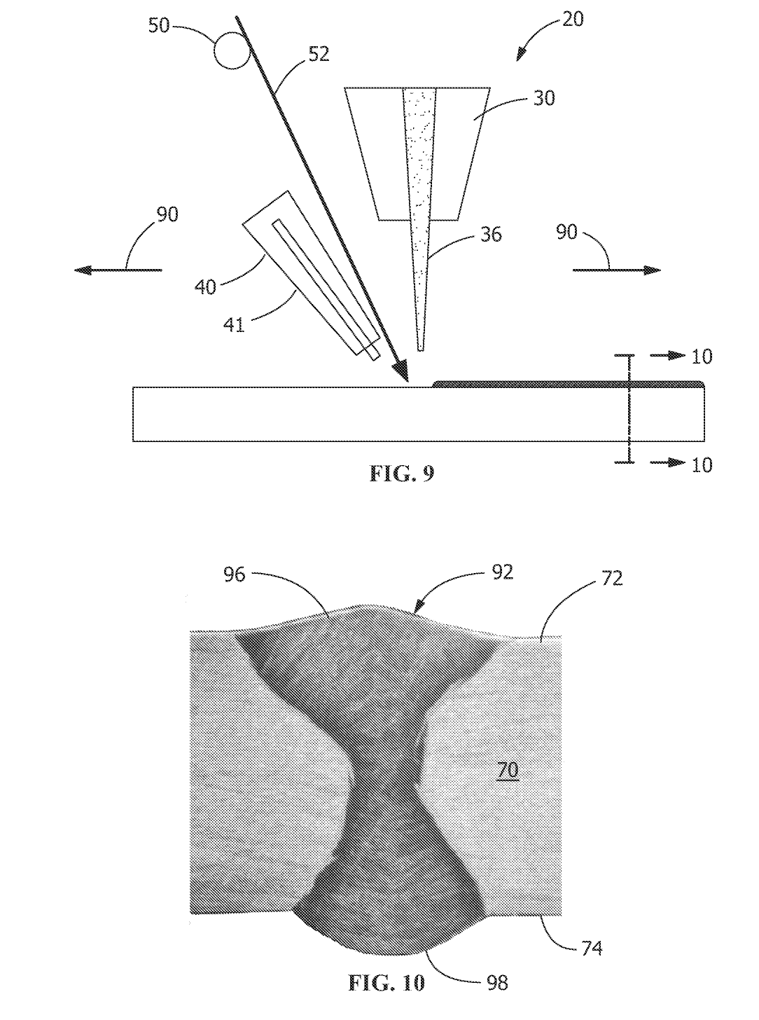

In FIG. 2, hybrid welding apparatus 20 has been removed to show common molten pool 60, shared molten pool 80, and arc area 46. Shared molten pool 80 is the area between laser beam 32 and arc area 46 of non-consumable electrode electric arc welder 40. The combined energy from beam 32 of laser 30 and electric arc welder 40 is directed toward aligned components 70 to shared molten pool 80. Common molten pool 60 is formed after wire is delivered to shared molten pool 80 and common molten pool 60 operates to provide a full penetration weld 92 to join components 70 at a high constant weld speed. As used herein, “shared molten pool” 80 refers to the molten material created by the weld arc 48 (see FIG. 1) of the non-consumable electrode electric arc welder 40 that includes a portion of the component 70 edges and energy from laser 30. As used herein, “common molten pool” 60 refers to the molten material created by the weld arc 48 (see FIG. 1) of electric arc welder 40 that includes a portion of the component 70 edges, energy from the laser 30 and wire 52 from wire feeding device 50. The molten material is further energized by beam 32 of laser 30 thereby causing the molten material to penetrate deeper into components 70. In one embodiment, shared molten pool 80 is larger in size than common molten pool 60. In another embodiment, common molten pool 60 may have a larger in size than shared molten pool 80. Arc area 46 is the zone around the electric arc 48 from electric welder 40 that provides additional energy or heat to first surface 72 of components 70. Generally, any materials within arc area 46 are energized or melted. Arc area 46 aids in melting wire 52 and adds additional energy to laser beam 36 to form common molten pool 60. Wire 52 becomes molten from arc area 46 and laser area 32 and is intermixed with the other molten materials in shared molten pool 80 to form a common molten pool 60 in weld direction 90. The intermixed molten materials of common molten pool 60, upon cooling, form one continuous piece or a full penetration weld 92 (see FIG. 9) joining components 70.

Materials for wire 52 are selected depending on desired weld characteristics such as weld strength, weld chemistry, and weld hardness. Suitable examples of materials for wire 52 include, but are not limited to, aluminum, iron, cobalt, copper, nickel, stainless steel, carbon steel, titanium, gold, silver, palladium, platinum, alloys thereof, and combinations thereof. Wire 52 is selected from cold wire or pre-heated hot wire. In one embodiment, wire 52 has a diameter range from about 0.63 millimeters (about 0.025 inches or 25 mils) to about 1.58 millimeters (about 0.062 inches or 62 mils) or alternatively from about 0.8 millimeters (about 0.03 inches or 30 mils) to about 1.4 millimeters (about 0.055 inches or 55 mils), or alternatively from about 0.9 millimeters (about 0.35 inches or 35 mils) to about 1.3 millimeters (about 0.51 inches or 51 mils).

In one embodiment, electric arc welder with non-consumable electrode 40 leads laser 30 in weld direction 90. In another embodiment, laser 30 leads in weld direction 90 (see FIG. 9). As shown in FIG. 2, distance 26 between laser beam 32 and arc area 46 is between approximately 1.0 millimeters to approximately 12 millimeters.

Non-consumable electric arc welder 40 establishes arc 48 and arc area 46 for melting portion of material of components 70. Laser 30 provides additional energy to allow weld to penetrate deeper in component 70. Wire 52 contributes additional material to weld and wire feeding device 50 allows for independent feeding of wire 52 into shared molten pool 80 to form common molten pool 60. In one embodiment, wire 52 is delivered into shared molten pool 80. Shared molten pool 80 is located between the arc 48 projection and the laser beam impingement spot 32, not under the electric arc. In one embodiment, when electric arc welder 40 leads and laser 30 trails, wire is delivered to a location which is close to the perimeter of the arc but not under the arc. The distance between wire 52 and the arc center is in a range of about 1 mm to about 10 mm, or alternatively about 2 mm to about 9 mm, or alternatively about 3 mm to about 8 mm. In another embodiment, when laser 30 leads and electric arc welder 40 trails wire is delivered to a location which is close to the laser beam 32 but not under the laser. The distance between wire 52 and laser beam 32 center is in a range of about 1 mm to about 10 mm, or alternatively about 2 mm to about 9 mm, or alternatively about 3 mm to about 8 mm. Electric arc welder 40 power may be reduced by decreasing arc 48 of electric arc welder 40. When power is reduced with electric arc welder with non-consumable 40, arc 48 remains stable. Wire 52 is deposited with wire feeding device 50 to provide additional material in shared molten pool 80 to form common molten pool 60 to form weld bead 92. Total heat input from non-consumable electric arc welder 40 and entire heat input to complete weld is reduced. Wire 52 from wire feeding device 50 is independently fed thereby reducing splattering along weld line and in material during joining of components 70.

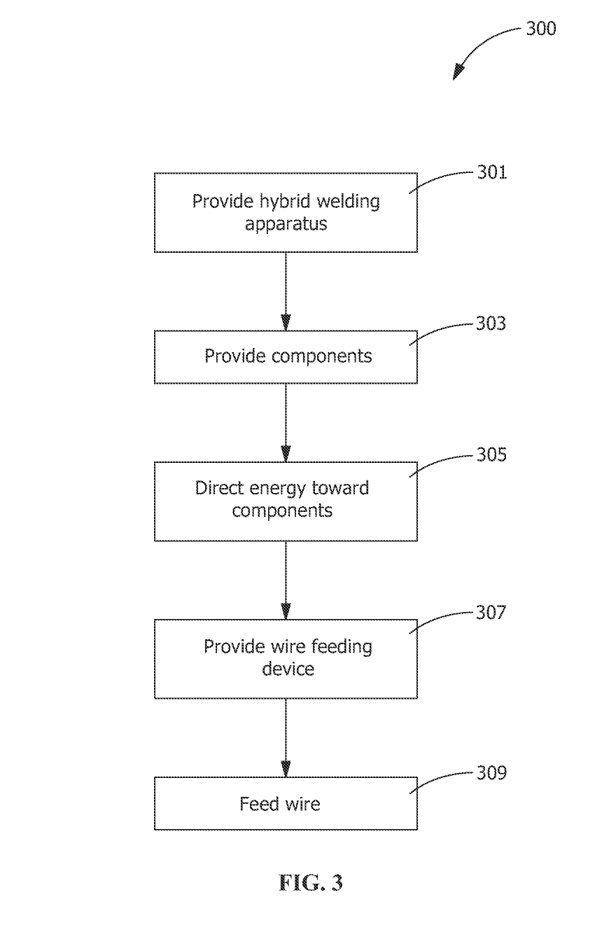

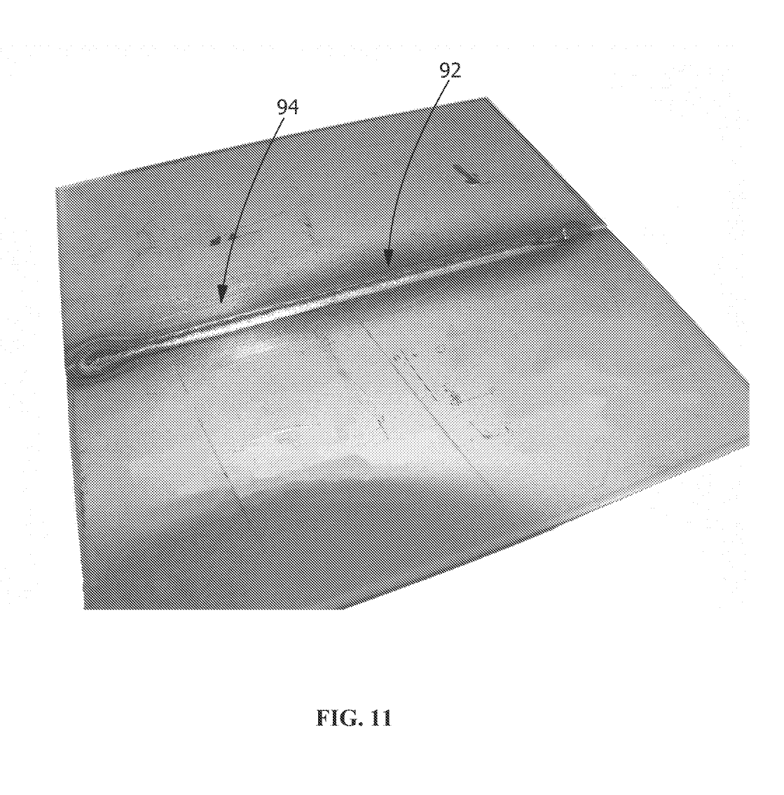

As shown in the flowchart of FIG. 3, method 300 of welding at least two adjacent components 70 using hybrid welding system 10 is provided. Method 300 includes providing hybrid welding apparatus 20, step 301. Method 300 further includes providing components 70, step 303 (see FIG. 1). Components 70 are adjacent to each other (see FIG. 2) and components 70 include any materials that are joinable or weldable, but generally include materials, such as, but not limited to, aluminum, titanium, steel, stainless steel, brass, copper, nickel, beryllium-copper, superalloy, alloys thereof and combinations thereof. Hybrid welding apparatus 20 includes laser 30 and electric arc welder with non-consumable electrode 40, such as, but not limited to, a GTAW or PAW. Hybrid welding system 10 also includes wire feeding device 50 for feeding wire 52 (see FIGS. 1 and 2). Wire feeding device 50 is located between electric arc welder with non-consumable electrode 40 and laser 30. Wire feeding device 50 is arranged and disposed to feed wire 52 to shared molten pool 80 and arc area 46 of electric arc welder 40 (see FIG. 2). Method 300 includes directing energy from hybrid welding apparatus 20 to components 70 to form shared molten pool 80 (see FIG. 2), step 305. Method 300 includes providing wire feeding device 50 situated between laser 30 and the non-consumable electrode electric arc welder 40 (see FIG. 1), step 307. Wire feeding device 50 is arranged and disposed to feed wire 52 into shared molten pool 80 to form common molten pool 60 (see FIG. 2). Method 300, includes feeding wire 50 into shared molten pool 80 to form common molten pool 60 (see FIG. 2), step 307. Common molten pool 60 is operable to join at least two adjacent components 70 without splattering (see FIG. 11).

The following examples are intended to further illustrate the present disclosure and the examples are not intended to limit the disclosure in any way.

### EXAMPLES

### Reference Example 1

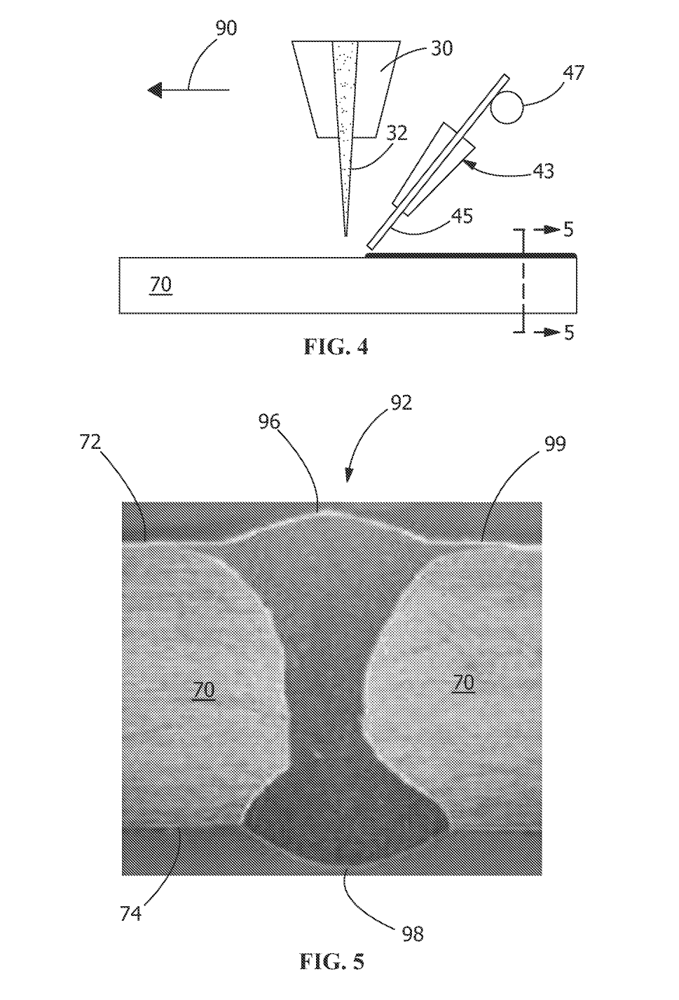

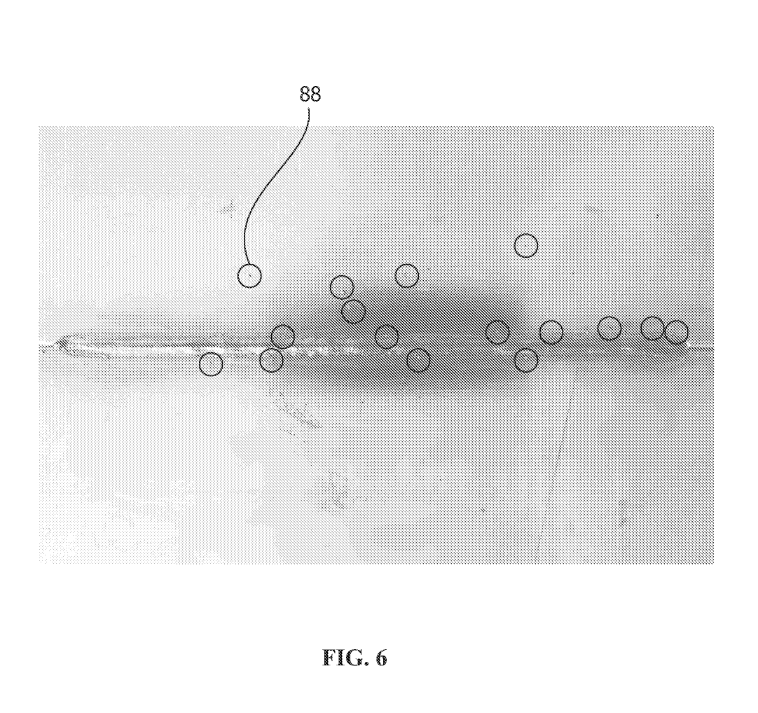

As shown in FIGS. 4 and 5, the first reference example includes joining two adjacent components 70 using a welding device. Welding device includes laser 30 having beam 32 and a consumable electrode electric arc welder 43. In this reference example, the consumable electric arc welder 43 is a GMAW torch with a consumable electrode 45 and a consumable electrode feeding device 47 for feeding consumable electrode 45. The welded components 70 were ⅛″ thick stainless steel (SS304, with a chemical composition of about 8-11% Ni, about 17.5-20% Cr, about 2% Mn, with balance Fe, available from Grainger Industrial Supply, Greer, S.C.) with a shear edge. The welding speed was 80 set to inches per minute (ipm). Laser 30 power was set at 4.0 kW and GMAW torch 43 setting was 230 ipm with a filler metal stainless steel (55308L, with a chemical composition of about 9-11% Ni, about 19.5-22% Cr, about 1.0-2.5% Mn with balance FE) and wire having a 0.889 millimeter (0.035 inch) diameter. As shown in FIG. 5, although a full penetration weld 92 was obtained, including top weld bead 96 and bottom weld bead 98; the weld 92 had a defect of overlaps 99. This defect is caused by improperly selected arc welding parameters. The low wire feeding speed of 230 ipm of the consumable electrode 45 of the GMAW torch 43 does not provide a stable GMAW arc, thereby resulting in splattering 88 as well as overlap defects, as shown in FIG. 6.

### Reference Example 2

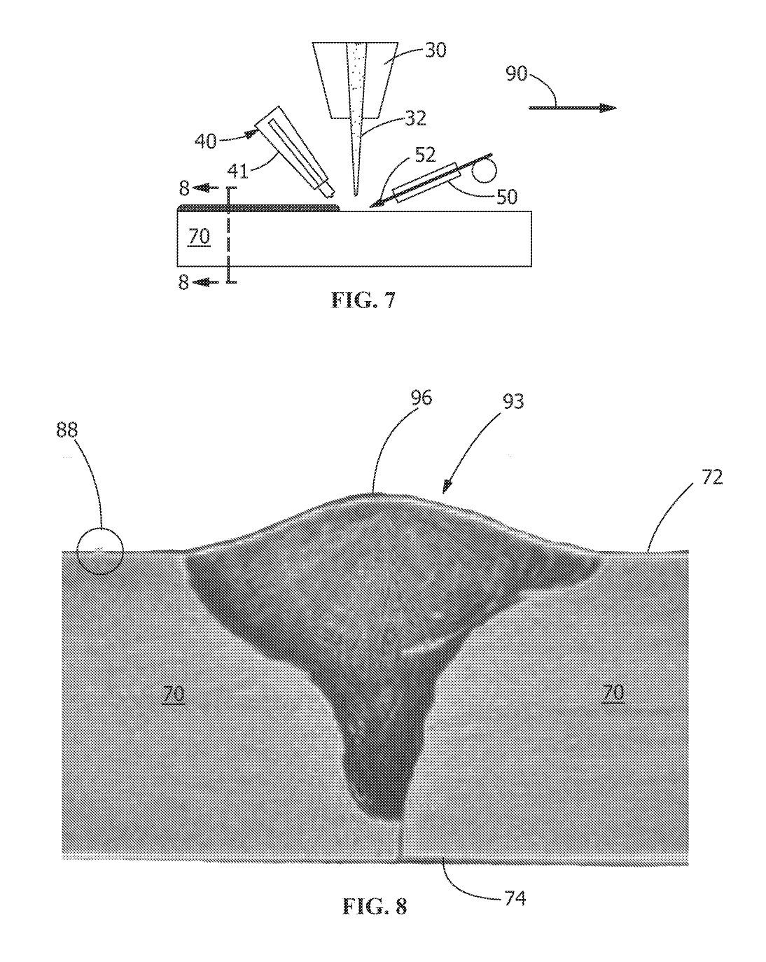

As shown in FIGS. 7 and 8, second reference example includes joining two adjacent components 70 using a welding device. Welding device includes laser 30 having beam 32, non-consumable electrode electric arc welder 40, and wire feeding device 50. Wire feeding device 50 is in front of laser 30. Non-consumable electrode electric arc welder 40 is a GTAW torch 41. Wire feeding device 50 feeds wire 52 in front of laser 30 and GTAW torch 41. As shown in FIG. 7, wire feeding device 50 leads laser 30 in weld direction 90. In this reference example, welded components 70 were ⅛″ thick stainless steel (SS304) with a shear edge. The welding speed was set to 80 ipm. Laser 30 power was set at 4 kW (maximum setting) and the GTAW torch 41 setting was 218 A/18V (maximum setting). The wire feeding speed of wire feeding device 50 was 230 ipm with a filler metal 308L wire 50 having diameter of about 0.889 millimeters (0.035 inches). The incomplete weld obtained from this example is shown in FIG. 8. As depicted, weld bead 93 obtained is not a full penetration weld because the weld does not extend from the first surface 72 of component 70 to second surface 74 of component 70. Only a top weld bead 96 is formed. The problem in this reference example is that the laser lost power for penetration due to the laser having to melt wire.

### Example 3

### Present Disclosure

As shown in FIGS. 9 and 10, an example of the present disclosure is provided. The present disclosure joins two adjacent components 70 using hybrid welding apparatus 20. In the present disclosure, the welded components 70 were ⅛″ thick stainless steel (SS304) with a shear edge. Hybrid welding apparatus 20 includes laser 30 and non-consumable electrode electric arc welder 40, and wire feeding device 50 between laser 30 and electric arc welder with non-consumable electrode 40. In this embodiment, non-consumable electric arc welder 40 is a GTAW torch 41. Laser 30 power was set to 3.6 kW and GTAW torch, is set at 200 A/18V. As shown in FIG. 9, laser 30 leads in welding direction 90. The welding speed was 80 ipm. Wire 50 feeding speed was 230 ipm with a filler metal 55308L having a 0.889 millimeter (0.035 inch) diameter and directed to shared molten pool 80 forming common molten pool 60 (see FIG. 2). As shown in FIG. 10, full penetration weld 92 including top weld bead 96 and bottom weld bead 98 was obtained with no splattering along the weld line 92 (see FIG. 11). Additionally, as shown in FIG. 11, full penetration weld 92 joins first surface 72 and second surface 74 (see FIG. 10) of components with no splattering 94 along the weld line and with less power from both laser 30 and non-consumable electrode electric arc welder 40 (GTAW).

In Reference Example 1, at the welding speed 80 ipm, laser with 4.0 kW combining with arc welder GMAW with wire feeding at 230 ipm could make a fully-penetrated weld but with overlap and spattering defects because the arc at this low wire feeding speed is not stable. In Reference Example 2, at an identical welding speed, 80 ipm, laser with 4.0 kW in power combining with arc welder GTAW at wire feeding of 230 ipm with the wire delivered in front of laser beam cannot make a fully-penetrated weld because the laser power is lost in the wire melting. In the present invention, at the identical welding speed, 80 ipm, a laser with 3.6 kW in power and in combination with arc welder GTAW at a wire feeding of 230 ipm with the wire delivered into a position which is located in the middle of the laser and arc, a fully-penetrated weld without any defects is obtained,

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A hybrid welding system comprising:
a hybrid welding apparatus, the hybrid welding apparatus having a laser and an electric arc welder with a non-consumable electrode, wherein the laser and the electric arc welder with the non-consumable electrode are arranged and disposed to direct energy toward at least two adjacent components to form a shared molten pool; and
a wire feeding device situated between the laser and the electric arc welder with the non-consumable electrode, the wire feeding device being arranged and disposed to feed a wire to the shared molten pool to form a common molten pool, the common molten pool being operable to join the at least two adjacent components without splattering and at a high constant weld speed.

2. The hybrid welding system of claim 1, wherein the laser is selected from the group consisting of: a Nd: YAG laser, a CO₂ laser, a fiber laser, and a disk laser.

3. The hybrid welding system of claim 1, wherein the electric arc welder with non-consumable electrode is selected from the group consisting of a gas tungsten arc welder and a plasma arc welder.

4. The hybrid welding system of claim 1, wherein the high constant weld speed is approximately 760 millimeters per minute to approximately 3050 millimeters per minute.

5. The hybrid welding system of claim 1, wherein the wire is cold wire or pre-heated hot wire.

6. The hybrid welding system of claim 1, where the wire is delivered into the shared molten pool.

7. The hybrid welding system in claim 1, the wire has a diameter range from 0.63 millimeters to 1.58 millimeters. (about 25 mils to about 62 mils).

8. The hybrid welding system of claim 1, wherein the at least two adjacent components to be welded include materials selected from the group consisting of titanium, nickel, iron, cobalt, chromium, steel, superalloys thereof, alloys thereof, and combinations thereof.

9. The hybrid welding system of claim 1, wherein the electric arc welder with non-consumable electrode is operated at a reduced energy level.

10. The hybrid welding system of claim 1, wherein the electric arc welder with non-consumable electrode has a stable arc.

11. The hybrid welding system of claim 1, wherein the wire of the wire feeding device is situated half-way between an arc of the electric arc welder with the non-consumable electrode and a beam of the laser.

12. The hybrid welding system of claim 1, wherein the wire of the wire feeding device is closer to the arc of the electric arc welder with the non-consumable electrode than the beam of the laser.

13. The hybrid welding system of claim 1, wherein the laser leads during welding with the wire following the laser and the electric arc welder with the non-consumable electrode following the wire of the wire feeding device.

14. The hybrid welding system of claim 1, wherein the electric arc welder leads during welding, with the wire following the electric arc welder with the non-consumable electrode and with the laser following the wire of the wire feeding device.

15. A method of welding at least two adjacent components comprising:
providing a hybrid welding apparatus, the hybrid welding apparatus, the hybrid welding apparatus having a laser and an electric arc welder with a non-consumable electrode, wherein the laser and the electric arc welder with the non-consumable electrode are arranged and disposed to direct energy toward at least two adjacent components to form a shared molten pool;
directing energy toward one or both of the adjacent components with the hybrid welding apparatus to form the shared molten pool;
providing a wire feeding device situated between the laser and the electric arc welder with the non-consumable electrode, the wire feeding device being arranged and disposed to feed a wire to the shared molten pool to form a common molten pool; and
feeding the wire into the shared molten pool to form a common molten pool, the common molten pool being operable to join the at least two adjacent components without splattering and at a high constant weld speed.

16. The method of claim 15, wherein the laser is a high-power density laser beam selected from the group consisting of a Nd: YAG laser, a CO₂ laser, a fiber laser, and a disk laser.

17. The method of claim 16, wherein the electric arc welder with the non-consumable electrode is selected from the group consisting of a gas tungsten arc welder, and a plasma arc welder.

18. The method of claim 15, wherein the electric arc welder with the non-consumable electrode is operated at a reduced energy level.

19. The method of claim 15, wherein the high constant weld speed is approximately 760 millimeters per minute to approximately 3050 millimeters per minute.

20. The method of claim 15, wherein the wire of the wire feeding device is situated half-way between an arc of the electric arc welder with the non-consumable electrode and a beam of the laser.
